(19) United States
(12) Patent Application Publication
(10) Pub. No.: US 2001/0044295 A1
(43) Pub. Date: Nov. 22, 2001

(54) COMMUNICATION CONTROL APPARATUS AND RADIO COMMUNICATIONS SYSTEM

(76) Inventors: MAKOTO SAITO, KANAGAWA (JP); MAKOTO KURIMOTO, KANAGAWA (JP)

Correspondence Address: HELFGOTT AND KARAS, 60TH FLOOR, EMPIRE STATE BUILDING, NEW YORK, NY, 101180110

(21) Appl. No.: 09/067,103

(22) Filed: Apr. 28, 1998

(30) Foreign Application Priority Data
Oct. 20, 1997 (JP) 9-287371

(51) Int. Cl. H04M 1/66; H04M 1/68; H04M 3/16

(52) U.S. Cl. 455/410

(57) ABSTRACT

A communication control apparatus for controlling a radio communications system, capable of detecting unauthorized clone terminals and protecting the system from the fraudulent use of telecommunication services. The radio communications system allows a plurality of subscriber terminals to communicate with each other, via radio base stations under the control of the proposed communication control apparatus. To detect unauthorized subscriber terminals, the apparatus comprises a response request signal transmission unit and a judgement unit. On predetermined conditions, the response request signal transmission unit transmits a response request signal containing an identification code of a specific subscriber terminal, by using a radio link via one of the base stations which covers an area where the specific subscriber terminal is based. Each subscriber terminal is configured to respond to the response request signal when the received identification code coincides with its own identification code. If a plurality of response signals have been received in reply to the response request signal, the judgement unit recognizes the presence of an unauthorized subscriber terminal (clone terminal) having the same identification code as that of the specific subscriber terminal.

### BACKGROUND OF THE INVENTION

1. Field of the Invention

The present invention relates to communication control apparatus and radio communications systems, and more particularly, to a communication control apparatus which manages the locations of subscriber terminals and controls originating and incoming calls to/from subscriber terminals. Further, the present invention relates to a radio communications system which involves the above communication control mechanisms.

2. Description of the Related Art

Wireless Local Loop (WLL) systems are known as telecommunication facilities which provide subscribers with standard telephone services by using wireless communication technologies in place of traditional copper wire connection to link subscriber terminals (telephones) with local switching systems. There is a basic premise in a WLL system that subscriber terminals do not move freely, but they are disposed at fixed locations. Even if the system allows some subscribers to move, they can roam only within a prescribed simultaneous paging area in which they are based. Outside this home location area, the subscriber terminals cannot register their current locations or handle any incoming and outgoing calls. These constraints are imposed to the subscriber terminals by a base station controller that governs simultaneous paging areas and manages subscriber data.

Since the radio medium can be accessed by anyone, the authentication of subscribers is an important issue in radio communications systems, including WLL, to permit the carrier to charge for communication services that each subscriber used. Without proper authentication mechanisms, radio communications systems would be exposed to the risk of fraudulent use of their services by some unauthorized subscribers. Such users act as if they were authorized genuine subscribers, by using their fake subscriber equipment, which is referred to as “clone terminals” in the present invention.

As their name implies, clone terminals have an exact copy of unique device parameters duplicated from genuine subscriber terminals, and thus the conventional radio communications systems cannot discriminate between them. The present invention provides several techniques to protect radio communications systems from fraudulent use by clone terminals. Further, the present invention provides a technique to detect clone terminals which possibly exist in a telecommunications network.

To address the above problem, researchers have proposed some methods to guard against illegal network access from clone terminals. According to one proposed method, each subscriber terminal encodes a randomly generated number by using its unique identifier (ID) as an encryption key, and sends the result to a relevant base station controller. With the received information, the base station controller proves that the subscriber terminal is what it claims to be. According to another proposed method, each subscriber terminal transmits certain variable data to prove itself as a regular subscriber terminal. This variable data is unique to the sending terminal and dynamically changes each time it is transmitted.

In the first proposed method using an encrypted random number, the subscriber terminal and base station controller share a secret ID code (or authentication key) that is uniquely assigned to each subscriber terminal. In the authentication procedure, the base station controller randomly generates a number and sends it to the subscriber terminal, and both parties separately encrypt the number by using the common authentication key. The cryptographic authentication algorithm used here is also common to the both parties. The subscriber terminal returns the resultant value to the base station controller to make a comparison between the two encrypted values, and when they agree with each other, the base station controller judges the terminal in question as a regular subscriber terminal.

Basically, this proposed method is considered resilient to eavesdropping, since the authentication data transmitted over the communication channel includes only a random number and its encrypted replica. This means, however, that it would lose its ability to guard the system against clone terminals' attack, if the authentication key and the cryptographic authentication algorithm were both stolen.

In actual implementation of this method, there are two options for the encryption algorithm to be used; one is to choose an appropriate algorithm from those which are publicly available, and another is to develop a proprietary, secret algorithm. Most practitioners take the first choice. While the second choice seems more secure than the first one, it is very difficult to develop a cryptographic algorithm that is hard to break, and simple and easy-to-develop algorithms are likely to be penetrated by outsiders. As such, the radio communications system would be exposed to the risk of fraudulent use by clone terminals, in case that the cryptographic algorithm was penetrated and the authentication key had leaked out in some illegal way.

On the other hand, the second proposed method using subscriber-specific variable data requires both the subscriber terminal and base station controller to share some appropriate data which dynamically changes with time or events and cannot be known by outsiders. Such variable data include, for example, the date and time record of the subscriber's last call and the call identification number used in that call. When starting a call, the subscriber terminal transmits the variable data to the base station controller. Confirming that the received data agrees with the data recorded in itself, the base station controller recognizes the terminal in question as a regular subscriber terminal.

The second method can be a very powerful way to protect the system against illegal users, in the case of mobile communications systems where regular subscriber terminals often change their locations. This is because the valid authentication data cannot be obtained by outsiders unless they always eavesdrop on a target subscriber's communication. In mobile systems, it is impossible for them to keep track of a subscriber who is roaming from one place to another. However, in the case that the subscriber terminals are disposed at fixed locations, as in WLL systems, an eavesdropper can always monitor every call that their target subscriber makes, to obtain the latest information that makes fraudulent authentication possible. If this is the case, the radio communications system will be exposed to the risk of illegal use of its services by the clone terminals.

It should be also noted here that both of the above-described methods are mainly aimed at the security of authentication processes, but not the detection of clone terminals.

### SUMMARY OF THE INVENTION

Taking the above into consideration, an object of the present invention is to provide a communication control apparatus and a radio communications system which detect the presence of clone terminals and the fraudulent use of telecommunication services.

To accomplish the above object, according to the present invention, there is provided a communication control apparatus, disposed in a radio communications system where a plurality of subscriber terminals communicate with each other via radio base stations, for managing locations of the subscriber terminals and controlling incoming and outgoing calls to/from the subscriber terminals. This radio communication control apparatus comprises: a response request signal transmission unit which transmits, upon predetermined conditions, a response request signal containing an identification code of a specific subscriber terminal by using a radio link via the base stations which cover an area where the specific subscriber terminal is located; and a judgement unit which recognizes the presence of an unauthorized subscriber terminal having the same identification code as the specific subscriber terminal's identification code, if a plurality of response signals have been received in reply to the response request signal intended for the specific subscriber terminal.

Further, to accomplish the above object, according to the present invention, there is provided a radio communications system which allows a plurality of subscriber terminals to communicate with each other via radio base stations by employing a communication controller coupled to the radio base stations for managing locations of the subscriber terminals and controlling incoming and outgoing calls to/from the subscriber terminals. This radio communications system comprises: a first functional unit which is activated upon predetermined conditions to transmit a response request signal from the communication controller to a specific subscriber terminal by using a radio link via the radio base stations which cover an area where the specific subscriber terminal is located, wherein said response request signal contains an identification code of the specific subscriber terminal; a second functional unit which transmits a response signal, in reply to the response request signal, from the subscriber terminal having the same identification code as that contained in the response request signal to the communication controller via the one of the radio base stations; and a third functional unit which recognizes the presence of an unauthorized subscriber terminal having the same identification code as the specific subscriber terminal's identification code, if a plurality of response signals have been returned in reply to the response request signal intended for the specific subscriber terminal.

The above and other objects, features and advantages of the present invention will become apparent from the following description when taken in conjunction with the accompanying drawings which illustrate [a] preferred embodiments of the present invention by way of example.

### BRIEF DESCRIPTION OF THE DRAWINGS

FIG. 1 is a conceptual view of the present invention;

FIG. 2 is a diagram which shows a typical configuration of a communication system employing a communication control apparatus proposed as a first embodiment of the present invention;

FIG. 3 is a diagram which shows the internal structure of a base station controller;

FIG. 4(A) is a diagram which shows the contents of a subscriber management table;

FIG. 4(B) is a diagram which shows the contents of a radio base station management table;

FIG. 5 is a flowchart which shows a process executed by a base station controller;

FIGS. 6 to 8 are the first to third sections of a sequence diagram which shows a process executed when an authorized terminal (SU1) and a clone terminal (SU1′) register their locations to the base station controller;

FIGS. 9 and 10 are the first and second halves of a sequence diagram which shows how the authorized terminal (SU1) and the clone terminal (SU1′) process an incoming call;

FIGS. 11 and 12 are the first and second halves of a sequence diagram which shows how the authorized terminal (SU1) and the clone terminal (SU1′) process an outgoing call;

FIGS. 13 and 14 are the first and second halves of a sequence diagram which shows how the authorized terminal (SU1) and the clone terminal (SU1′) process a simulated incoming call transmitted on a regular basis; and

FIGS. 15 and 16 are the first and second halves of a sequence diagram which shows how the authorized terminal (SU1) and the clone terminal (SU1′) process an outgoing call in the second embodiment.

### DESCRIPTION OF THE PREFERRED EMBODIMENTS

Several embodiments of the present invention will be described below, with reference to the accompanying drawings.

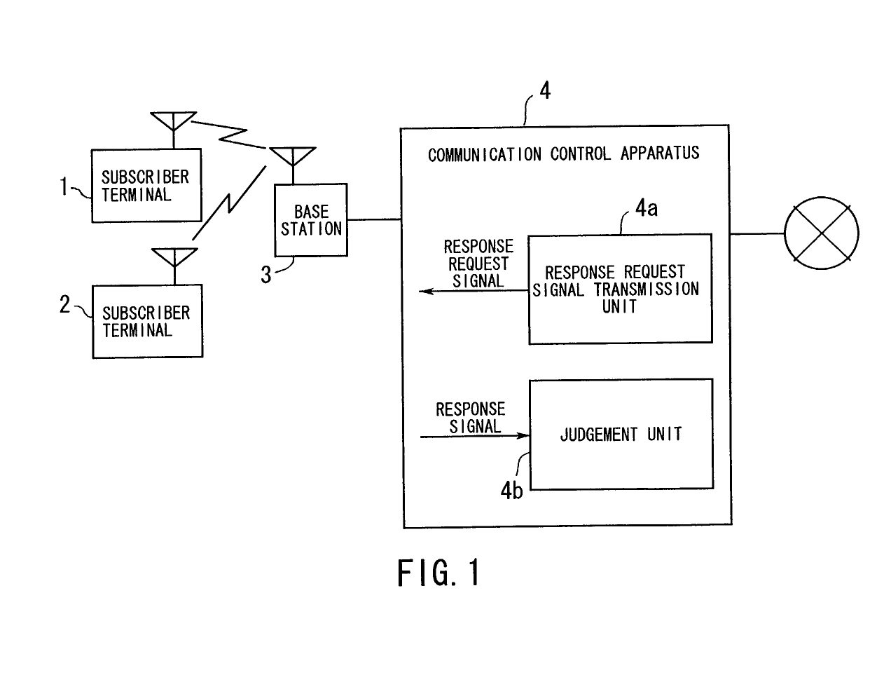

Referring first to FIG. 1, the following section will describe the concept of a first embodiment of the present invention. FIG. 1 shows a block diagram of a communication control apparatus 4 of the first embodiment, which comprises: a response request signal transmission unit 4a which transmits, upon predetermined conditions, a response request signal containing an identification code of a specific subscriber terminal (say, subscriber terminal 1) by using a radio link via a base station 3 covering an area where the subscriber terminal 1 is based; and a judgement unit 4b which recognizes the presence of an unauthorized subscriber terminal having the same identification code as that of the subscriber terminal 1, when a plurality of response signals have been received in reply to the response request signal intended for the subscriber terminal 1.

In operation of the above structural arrangement, the response request signal transmission unit 4a transmits a response request signal containing an identification code of the subscriber terminal 1 by using a radio link via the base station 3 covering an area where the subscriber terminal 1 resides. The transmission is conducted on predetermined conditions, including: (a) when the subscriber terminal 1 has requested the registration of its location; (b) when the subscriber terminal 1 has originated a call; (c) when there is an incoming call to the subscriber terminal 1; and (d) at scheduled intervals.

Upon receipt of the response request signal, each subscriber terminal in the base station 3's coverage area compares the identification code in the received signal with its own identification code. If they coincide with each other, the subscriber terminal returns a response signal to the communication control apparatus 4, again via the base station 3, while making its own identification code included as part of the response signal. In the present case, the subscriber terminal 1 transmits such a response signal.

After sending the response request signal, the judgement unit 4b in the communication control apparatus 4 waits for a corresponding response signal returning from the intended subscriber terminal. If there is no clone terminal, the judgement unit 4b will receive only one response signal. However, if there exists a clone terminal faking the subscriber terminal 1 with its duplicate identification code, this clone terminal will also respond to the same response request signal by returning a response signal to the communication control apparatus 4. Accordingly, the presence of a clone terminal (or clone terminals) will cause a plurality of response signals to be sent back to the communication control apparatus 4. When a plurality of response signals have been received, the judgement unit 4b in the communication control apparatus 4 recognizes the presence of an unauthorized subscriber terminal (or clone terminal), in addition to the authorized subscriber terminal 1, which has the same identification code as that of the subscriber terminal 1.

If the judgement unit 4b has found a clone terminal, then the communication control apparatus 4 takes appropriate measures such as disconnection of communication channels for all subscriber terminals having the subscriber terminal 1's identification code. In this way, the proposed communication control apparatus 4 makes it possible to detect the presence of a clone terminal and to protect the telecommunications system from illegal use.

Now, the following section will describe the first embodiment of the present invention in more detail.

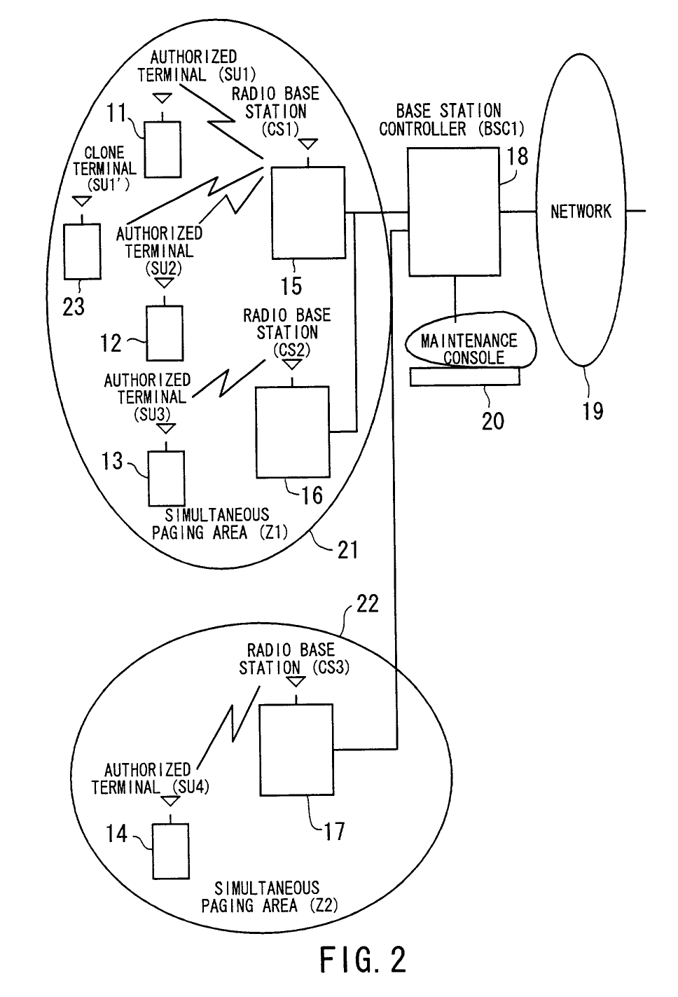

FIG. 2 shows a typical configuration of a communication system employing a communication control apparatus according to the first embodiment of the present invention. This system comprises: authorized terminals (SU1 to SU4) 11 to 14 which have been enrolled through a proper registration procedure, radio base stations (CS1 to CS3) 15 to 17, a base station controller 18, a network 19 with circuit switching facilities, and a maintenance console 20. The authorized terminals 11 to 13 and the radio base stations 15 and 16 are located in a simultaneous paging area (Z1) 21, while the authorized terminal 14 and the radio base station 17 are located in another simultaneous paging area (Z2) 22.

The authorized terminals 11 to 14 are connected to their local radio base stations 15 to 17 through radio link channels which conform to the Research and Development Center for Radio System standards RCR-28. The radio base stations 15 to 17 control radio link channels in their respective coverage area, and the base station controller 18 processes calls between the authorized terminals 11 to 14 and the network 19. The details of their internal structure and operation will be described later. The authorized terminals 11 to 14 have their own identification codes called “Personal Station-Identifiers” (PS-ID) to uniquely distinguish themselves from each other.

For illustrative purposes, the following discussion assumes that a clone terminal (SU1′) 23 resides in the simultaneous paging area (Z1) 21. This clone terminal 23 is an unauthorized subscriber terminal that fakes the authorized terminal (SU1) 11 by using the same PS-ID duplicated in some illegal way. As an alternative arrangement, the terminals can be configured to use their phone numbers for identification codes, although the RCR28 standards stipulate the use of PS-IDs.

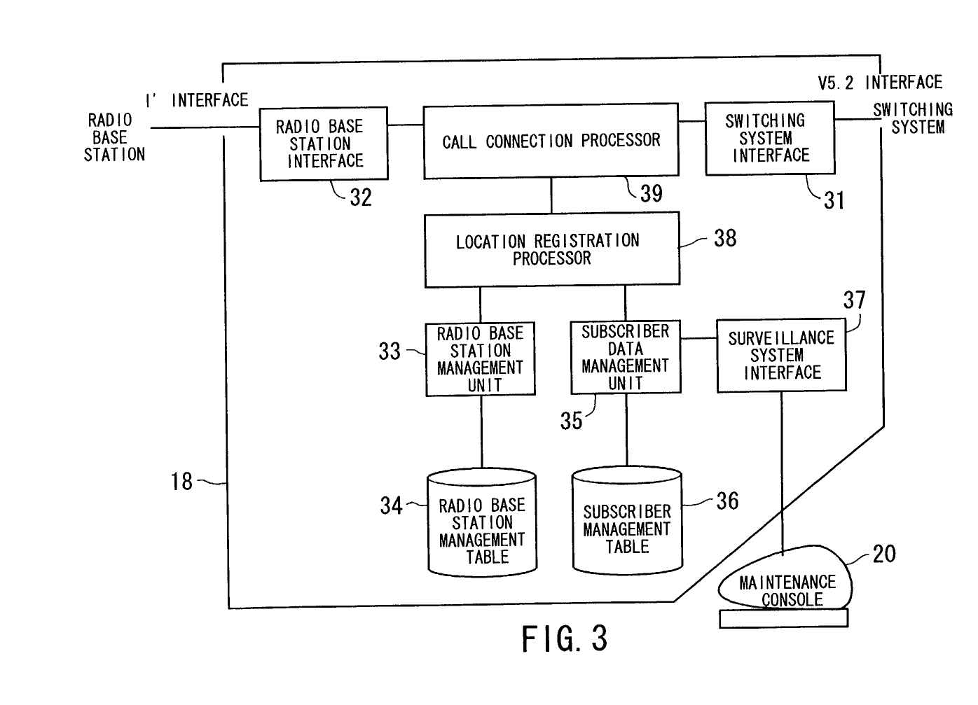

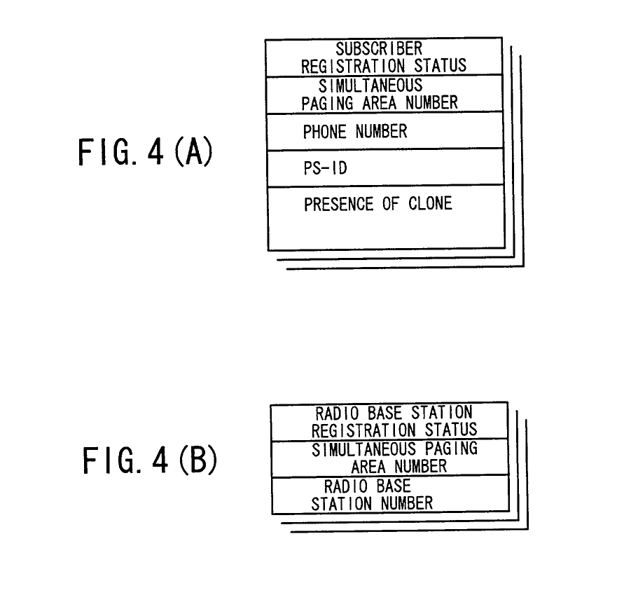

FIG. 3 shows the internal structure of the base station controller 18. A switching system interface 31 is responsible for the communication with a switching system deployed on the network 19, which uses V5.1 and V5.2 communication protocols formulated by European Telecommunications Standard Institute (ETSI). A radio base station interface 32, on the other hand, supports the communication with the radio base stations 15 to 17. The RCR-28 I′ interface protocol is used in this communication. A radio base station management unit 33 maintains a radio base station management table 34 which stores a list of radio base stations in each simultaneous paging area, including the registration status and the simultaneous paging area number of each radio base station. A subscriber data management unit 35 maintains a subscriber management table 36 which stores various information about individual authorized subscriber terminals. More specifically, the subscriber management table 36 describes each terminal by showing its registration status, its PS-ID, and simultaneous paging area where it belongs. The subscriber management table 36 also indicates the presence of clone terminals corresponding to the individual authorized terminals. The details of these radio base station management table 34 and subscriber management table 36 will be provided later on, with reference to FIGS. 4(A) and 4(B).

A surveillance system interface 37 is used for the collection and setting of subscriber data, as well as supporting the communication with the maintenance console 20. A location registration processor 38 interacts with authorized terminals to carry out a location registration sequence for them. Referring to the subscriber management table 36 and radio base station management table 34, the location registration processor 38 also determines the validity of each location registration (i.e., whether the terminals' have properly registered their locations within the relevant simultaneous paging area, or their respective home location areas). A call connection processor 39 interacts with the authorized terminals to execute a call connection sequence. Referring to the subscriber management table 36 and radio base station management table 34, it also determines the validity of each call connection (i.e., whether the call in process has been originated from a correct location within the relevant simultaneous paging areas). With the elements described above, the base station controller 18 processes location registration, call origination, and other sequences requested by an authorized terminal. That is, the base station controller 18 extracts a PS-ID from the received request signal, retrieves records relevant to the extracted PS-ID from the radio base station management table 34 and subscriber management table 36, and confirms that the request has been generated within a correct simultaneous paging area where the requesting terminal is authorized to operate.

Being composed of a CPU, ROM, RAM, and other computer components, the call connection processor 39 functions as the response request signal transmission unit 4a and judgement unit 4b described in FIG. 1.

FIG. 4(A) illustrates the subscriber management table 36, particularly a record describing a specific authorized terminal. As FIG. 4(A) shows, the record consists of: a “Subscriber Registration Status” field to indicate whether the authorized terminal is registered or unregistered, a “Simultaneous Paging Area Number” field to store the identification number of a simultaneous paging area where the authorized terminal is based, a “Phone Number” field to store the authorized terminal's phone number, a “PS-ID” field to store the authorized terminal's PS-ID, and a “Presence of Clone” field to indicate whether a clone terminal faking the authorized terminal has been detected or not.

FIG. 4(B) illustrates the radio base station management table 34, particularly a record describing a specific radio base station. As FIG. 4(B) shows, the record consists of: a “Radio Base Station Registration Status” field to indicate whether the radio base station is registered or unregistered, a “Simultaneous Paging Area Number” field to store the identification number of a simultaneous paging area where the radio base station is deployed, and a “Radio Base Station Number” field to store the radio base station's identification number.

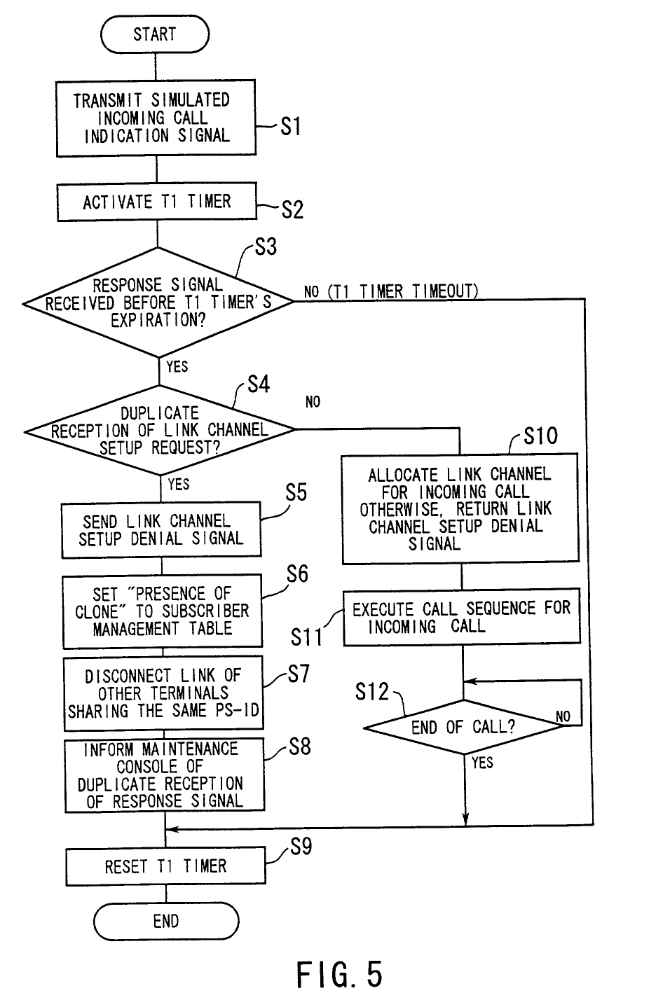

Referring now to FIG. 5, the following paragraphs will explain a process executed by the base station controller 18 configured as above.

FIG. 5 is a flowchart which shows the process executed by the base station controller 18. The process described in this flowchart is invoked by either of the following events:

(a) Location Registration - - - when the location registration processor 38 has completed a location registration process which was initiated by an authorized terminal or a clone terminal, as part of their power-up procedure,

(b) Call Origination - - - when the call connection processor 39 has received a setup signal from a radio base station at the beginning of a call origination process requested by an authorized terminal or a clone terminal,

(c) Reception of Incoming Call - - - when the call connection processor 39 has received an incoming call from the network 19, and

(d) Regular Interval - - - when the call connection processor 39 has detected the expiration of a predetermined time interval (i.e., the process is programmed to run at predetermined intervals).

For illustrative purposes, it is assumed here that the base station controller 18 has encountered either one of the four events (a) to (d) listed above, and the authorized terminal 11 is involved in that event. Further, consider that the subscriber management table 36 has a record pertaining to the authorized terminal 11, and its “Presence of Clone” field is indicating no clones at this point in time. The following will describe the process of FIG. 5 according to the order of step numbers (S1-S12).

(S1) The call connection processor 39 transmits a simulated incoming call signal containing the authorized terminal 11's PS-ID to the simultaneous paging area 21 where the authorized terminal 11 is registered. This simulated incoming call signal corresponds to the response request signal described in FIG. 1.

The primary role of the call connection processor 39 is to respond to an incoming call by sending an incoming call indication signal to the called terminal and then allocating a radio link channel in response to a link channel setup request signal to be returned from the called terminal. The call connection processor 39 performs this process routinely in response to every incoming call. Additionally, in the present invention, the call connection processor 39 is designed to simulate an incoming call indication signal upon location registration, upon call origination, or at a regular interval. This “simulated incoming call indication signal” is not based on a true incoming call, but just “simulated” by the call connection processor 39. Because these two signals are indistinguishable to the receiver's eyes, the called terminal returns a link channel setup request signal in an attempt to accept the call. However, unlike the routine process mentioned above, the call connection processor 39 will deny the request for a link channel allocation, since the incoming call indication was only a “simulated” signal.

As such, the call connection processor 39 generates two kinds of incoming call indication signals. However, for the simplicity of explanation, the following sections will use the term “simulated incoming call indication signal,” inclusively of the two meanings.

(S2) After transmitting the simulated incoming call indication signal, the call connection processor 39 activates a T1 timer. This T1 timer is an interval timer for signaling the expiration of a predetermined time, which is set to be a little longer than the interval from the transmission of a simulated incoming call indication signal to the arrival of a response signal at the call connection processor 39 from the authorized terminal 11 or the clone terminal SU1′ 23.

(S3) The call connection processor 39 waits for a response signal returning from the authorized terminal 11, or possibly from the clone terminal 23. The process then advances to step S4 if the response signal has arrived before the T1 timer expires. Otherwise, the process skips to step S9.

(S4) If the call connection processor 39 has received a response signal, or a link channel setup request signal, from both of the authorized terminal 11 and the clone terminal 23, the process advances to step S5. When it has received the signal only from the authorized terminal 11, the process branches to step S10.

(S5) The call connection processor 39 recognizes the presence of a clone terminal, but it is unable to identify which terminal, 11 or 23, is the clone. Accordingly, the call connection processor 39 denies the second link channel setup request signal, as a countermeasure for the time being.

(S6) The call connection processor 39 updates the subscriber management table 36 by setting a flag indicating the existence of a clone terminal to the “Presence of Clone” field relevant to the authorized terminal 11.

(S7) In the case that the process has originally been initiated by an outgoing call or an incoming call, the subscriber terminal that issued a link channel setup request earlier than the other is considered to have an established connection or to be in the process of call connection at the time point of step S7. The call connection processor 39 disconnects the established connection, or aborts the call connection process for this subscriber terminal.

(S8) The call connection processor 39 then notifies the maintenance console 20 that it has received two response signals for a single simulated incoming call indication signal transmitted.

(S9) The call connection processor 39 resets the T1 timer.

(S10) The call connection processor 39 understands that no clone terminal is present, as far as the subscriber terminal 11 is concerned. Accordingly, the call connection processor 39 accepts a subsequent link channel setup request signal and allocates a link channel to the subscriber terminal 11, in the case that the present process has been invoked by an incoming call. In the case that the present process has been invoked by the completion of location registration or the expiration of the predetermined interval, the call connection processor 39 denies the link channel setup request signal, because it knows that this response has derived from the “simulated” incoming call indication In the case that the process has originally been invoked by an outgoing call, the process advances NO in step S3.

(S11) The base station controller 18 executes a routine process for an incoming call, when the present process has originally been invoked by an incoming call.

(S12) The process advances to step S9 after the completion of the present call, in the case that the present process has originally been invoked by an incoming call.

As mentioned earlier, the above explanation of the flowchart of FIG. 5 assumes that, at the time when the process is invoked, the subscriber management table 36 has a record pertaining to the authorized terminal 11 whose “Presence of Clone” field is indicating no clones. When, in turn, the “Presence of Clone” field indicates the presence of a clone terminal, the operation of the call connection processor 39 will be different from the above. Consider again that the process of FIG. 5 is invoked by the same event. Then the call connection processor 39 retrieves a record relevant to the authorized terminal 11 from the subscriber management table 36, thus readily understanding that there is a clone terminal 23 faking the authorized terminal 11. Accordingly, the call connection processor 39 denies any link channel setup requests from the clone terminal 23 or the authorized terminal 11.

Once the presence of the clone terminal 23 is identified, it is no longer possible for the authorized terminal 11 to use the services. In order to regain access to the network, the subscriber terminal 11 should be reconfigured by an authorized maintenance engineer so that it will have a new PS-ID. That is, the maintenance engineer should replace or rewrite the ROM in the authorized terminal 11 to set a new PS-ID and then update the subscriber management table 36 by operating the maintenance console 20. The relevant “Presence of Clone” field is now reset to a “No Clones” state, and the “PS-ID” field contains the new identification code which permits the authorized terminal 11 to operate again.

As described earlier, the base station controller 18 is activated in response to the following four events: (a) upon location registration, (b) upon reception of an incoming call, (c) upon origination of an outgoing call, and (d) at a regular interval. Now, the next section will explain the operation of the base station controller 18 by separately considering each individual situation.

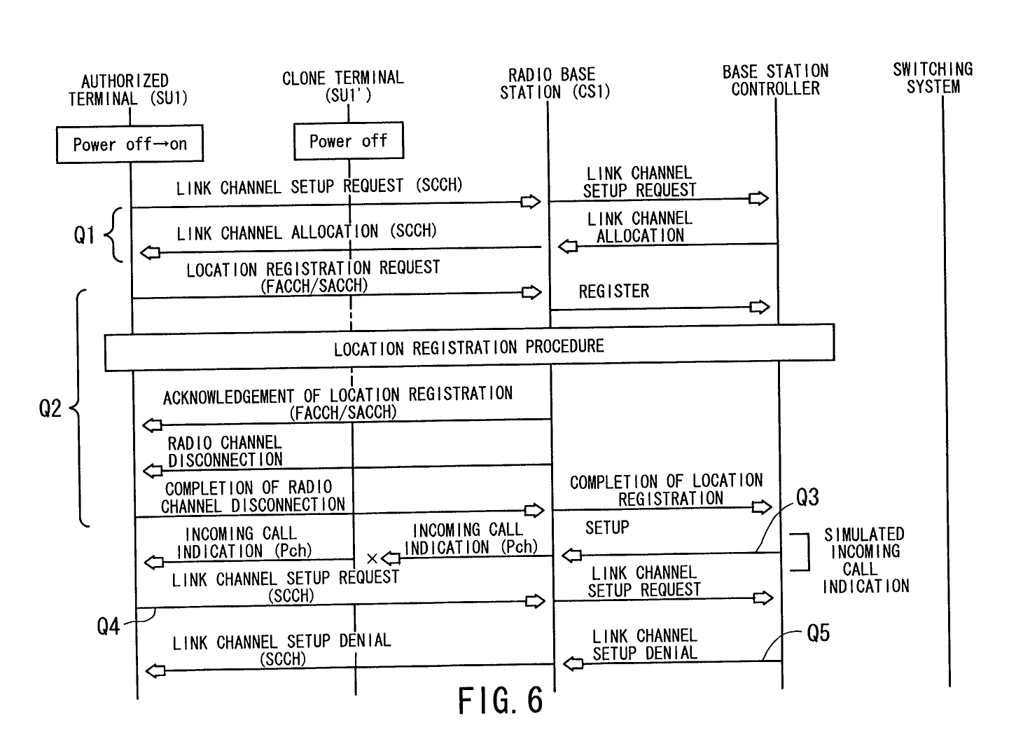

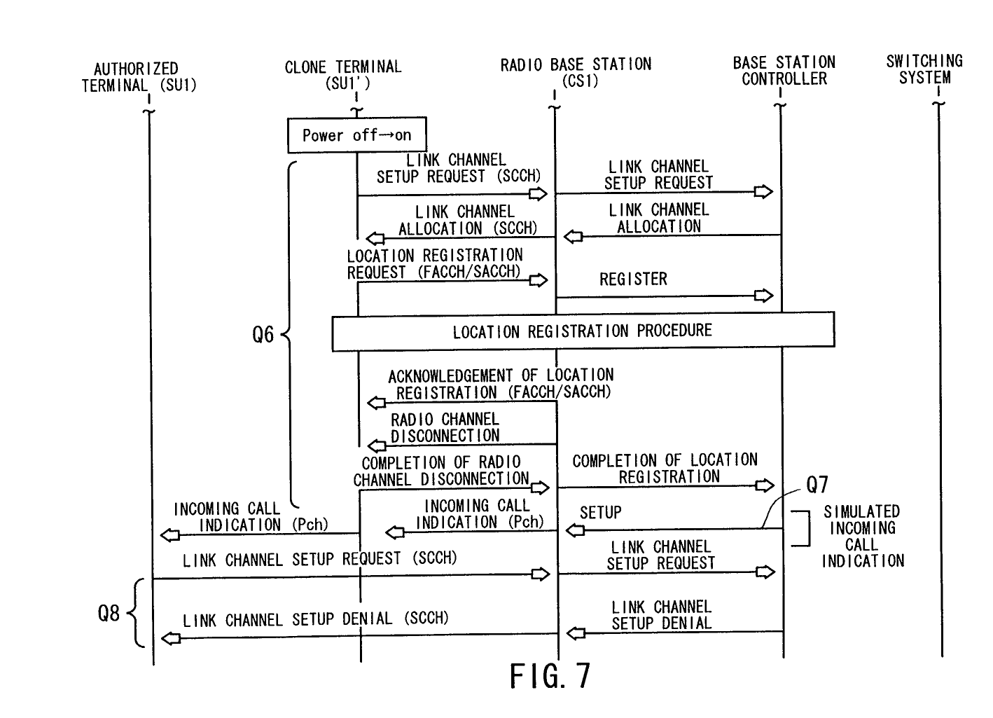

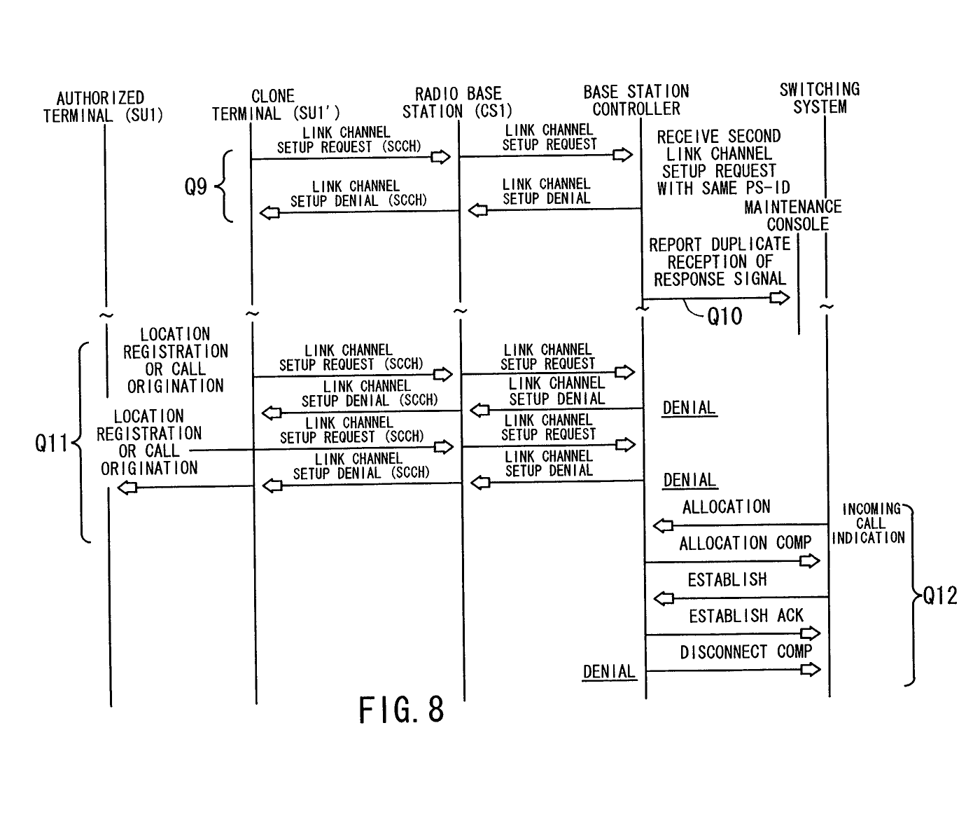

FIGS. 6 to 8 show the process to be executed when the authorized terminal (SU1) 11 and the clone terminal (SU1′) 23 attempt to register their locations to the base station controller 18. The process starts with FIG. 6 and continues to FIG. 7 and then to FIG. 8. The following will describe the sequence of FIGS. 6 to 8, referring to the step numbers Q1 to Q12 as required.

It is now assumed that the authorized terminal (SU1) 11 is powered up, while the clone terminal (SU1′) 23 is still disabled. Upon power-up, the genuine terminal (SU1) 11 transmits a link channel setup request signal to the base station controller 18 via the radio base station (CS1) 15. In reply to the request signal, the base station controller 18 returns a link channel allocation signal to the requesting authorized terminal (SU1) 11 (Step Q1). Once the link channel is assigned, the authorized terminal (SU1) 11 starts a series of transactions with the radio base station (CS1) 15 and the base station controller 18 to register its location (Step Q2). Note that FIG. 6 shows several abbreviations to indicate which radio channel is used in each transaction, including: “SCCH” for “Signaling Control Channel,” “FACCH” for “Fast Associated Control Channel,” “SACCH” for “Slow Associated Control Channel.”

When the requested location registration is done, the location registration processor 38 in the base station controller 18 informs the call connection processor 39 of the completion. The call connection processor 39 produces an incoming call indication signal containing the registered authorized terminal (SU1) 11's PS-ID, and then transmits it to the radio base station (CS1) 15 for distribution in the simultaneous paging area 21 where the authorized terminal (SU1) 11 is based (Step Q3). To be exact, this signal is a “simulated” incoming call indication signal because no incoming calls are present. In this step Q3, the call connection processor 39 further activates the T1 timer. Note that the term “Pch” shown in FIG. 6 stands for a “Paging Channel.”

The authorized terminal (SU1) 11 receives the incoming call indication signal addressed to itself, and in response to this, it sends a link channel setup request signal containing its own PS-ID back to the base station controller 18 via the radio base station (CS1) 15 (Step Q4). While having the same PS-ID as that of the authorized terminal (SU1) 11, the clone terminal (SU1′) 23 sends no link channel setup request signal, because it has not been powered on.

The call connection processor 39 in the base station controller 18 receives the link channel setup request signal before the T1 timer expires. Since this request has been derived from the “simulated” incoming call indication, the call connection processor 39 returns a link channel setup denial signal to the authorized terminal (SU1) 11 (Step Q5). Note that there was only one instance of the link channel setup request signal received before the T1 timer expires. Therefore, the call connection processor 39 takes this as a normal response, and thus it terminates the sequence of the simulated incoming call indication.

Suppose here that the clone terminal (SU1′) 23 is now powered on. This triggers a series of transactions among the clone terminal (SU1′) 23, the radio base station (CS1) 15, and the base station controller 18 to register the location (Step Q6). When the location registration procedure is finished, the call connection processor 39 transmits to the simultaneous paging area (Z1) 21 an incoming call indication signal (a “simulated” version, to be exact) containing the PS-ID of the clone terminal (SU1′) 23 that has just been registered (Step Q7).

Recognizing that the received incoming call indication signal is addressed to itself, the authorized terminal (SU1) 11 sends a link channel setup request signal containing its own PS-ID to the base station controller 18. The call connection processor 39 in the base station controller 18 receives the link channel setup request signal before the Ti timer expires, and it returns a link channel setup denial signal to the authorized terminal (SU1) 11 (Step Q8).

Similarly, the clone terminal (SU1′) 23 recognizes the same incoming call indication signal as being addressed to itself, and thus it sends a link channel setup request signal containing its own PS-ID to the base station controller 18. The call connection processor 39 in the base station controller 18 receives this second link channel setup request signal before the T1 timer expires, and it returns a link channel setup denial signal to the clone terminal (SU1′) 23 (Step Q9).

As a result of steps Q8 and Q9, the call connection processor 39 has received two link channel setup request signals in total, thus making a judgement that a clone terminal having the same PS-ID as that of the authorized terminal (SU1) 11 exists in the simultaneous paging area 21. Accordingly, the call connection processor 39 reports this abnormality to the maintenance console 20 (Step Q10). The call connection processor 39 now sets an appropriate value to the “Presence of Clone” field relevant to authorized terminal (SU1) 11 to indicate the existence of a clone terminal, and then terminates the sequence of the simulated incoming call indication.

Now that the presence of a clone terminal is registered in the subscriber management table 36, the base station controller 18 rejects any further link channel setup request signals from the terminals concerned. That is, even if the authorized terminal (SU1) 11 or clone terminal (SU1′) 23 wishes to make a location registration or call origination, their request for link channel allocation will be denied by the call connection processor 39 (Step Q11). Such an access denial is also applied to incoming calls from the switching system on the network 19 (Step Q12).

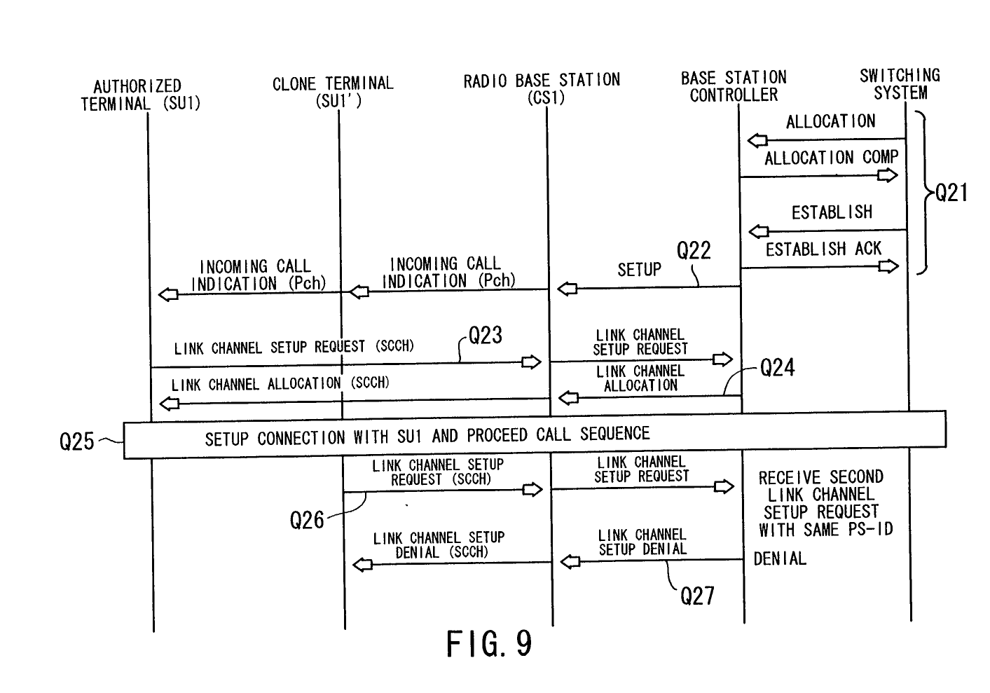

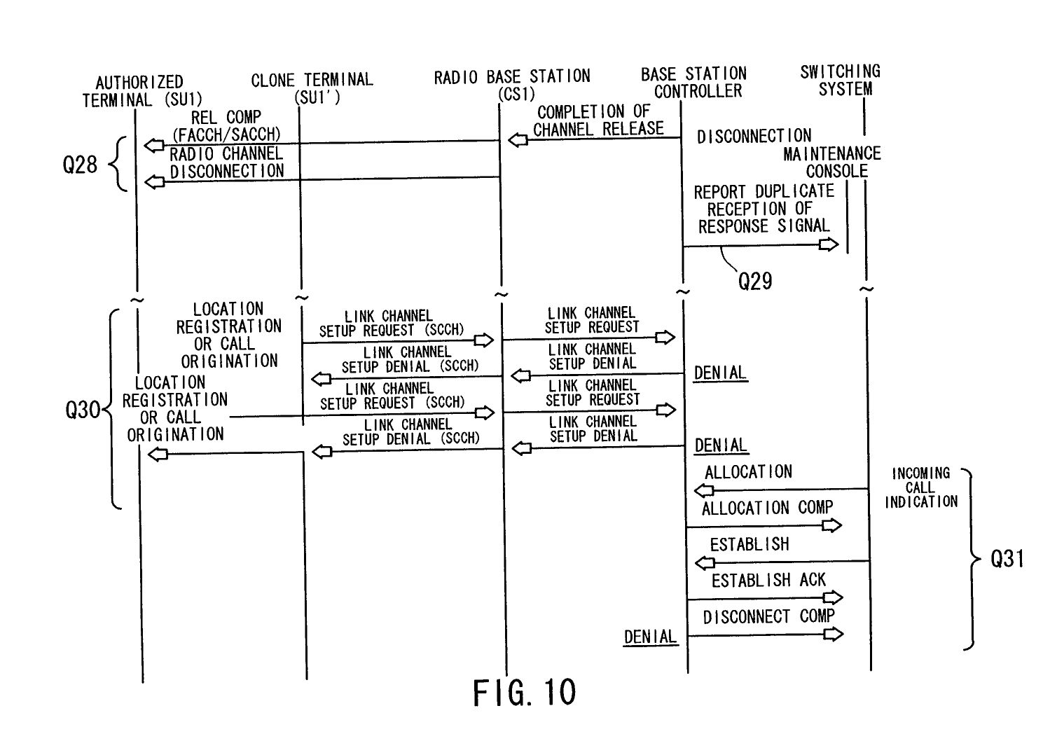

FIGS. 9 and 10 are the first and second halves of a sequence diagram which shows how the authorized terminal (SU1) 11 and the clone terminal (SU1′) 23 process an incoming call. The following will describe the sequence of FIGS. 9 and 10, referring to the step numbers Q21 to Q31 as required.

The process starts with a transaction between the switching system on the network 19 and the base station controller 18 to handle an incoming call addressed to the authorized terminal (SU1) 11 (Step Q21). This step is followed by the transmission of an incoming call indication signal conveying the PS-ID of the authorized terminal (SU1) 11, from the call connection processor 39 in the base station controller 18 to the simultaneous paging area 21 via the radio base station (CS1) 15 (Step Q22). At the same time, the call connection processor 39 activates the T1 timer.

The transmitted incoming call indication signal is received by both the authorized terminal (SU1) 11 and the clone terminal (SU1′) 23. Consider that the authorized terminal (SU1) 11, for example, responds to the indication signal by sending a link channel setup request signal having its own PS-ID to the base station controller 18 via the radio base station (CS1) 15 (Step Q23). In reality, it may happen that the clone terminal (SU1′) 23 sends the same request signal earlier than the authorized terminal (SU1) 11.

The call connection processor 39 in the base station controller 18 now receives the link channel setup request signal before the T1 timer expires. Since this request is based on a true incoming call indication, the call connection processor 39 returns a link channel allocation signal to the authorized terminal (SU1) 11 (Step Q24). Subsequently, a call connection procedure is executed through the transactions among the authorized terminal (SU1) 11, the switching system, and the base station controller 18. Upon establishment of the connection, the requested communication services become available to the users (Step Q25).

The clone terminal (SU1′) 23, on the other hand, has received the same incoming call indication signal addressed to itself, and thus it returns a link channel setup request signal with its own PS-ID to the base station controller 18 (Step Q26). The call connection processor 39 in the base station controller 18 receives this second link channel setup request signal before the T1 timer expires. Because of the duplicate reception of the same link channel setup request signal, it determines that a clone terminal having the same PS-ID as the authorized terminal (SU1) 11's exists in the simultaneous paging area 21. Accordingly, the call connection processor 39 sends a link channel setup denial signal to the clone terminal (SU1′) 23 (Step Q27).

After that, the call connection processor 39 interrupts the present operation of the authorized terminal (SU1) 11 by aborting the call connection process if it is still in progress, or by disconnecting the call if it is in session (Step Q28). Further, the call connection processor 39 recognizes the presence of a clone terminal faking the authorized terminal (SU1) 11, and reports the problem to the maintenance console 20 (Step Q29). Moreover, the call connection processor 39 updates the “Presence of Clone” field relevant to the authorized terminal (SU1) 11 to indicate the existence of a clone terminal, and then terminates the sequence for the incoming call.

As long as the presence of a clone terminal is registered in the subscriber management table 36, the base station controller 18 continues to reject any further link channel setup request signals from the terminals concerned. That is, even if the authorized terminal (SU1) 11 or clone terminal (SU1′) 23 desires to make a location registration or call origination, their request for link channel allocation will be denied by the call connection processor 39 (Step Q30). Such an access denial is also applied to any incoming calls to the authorized terminal (SU1) 11 signaled from the switching system on the network 19 (Step Q31).

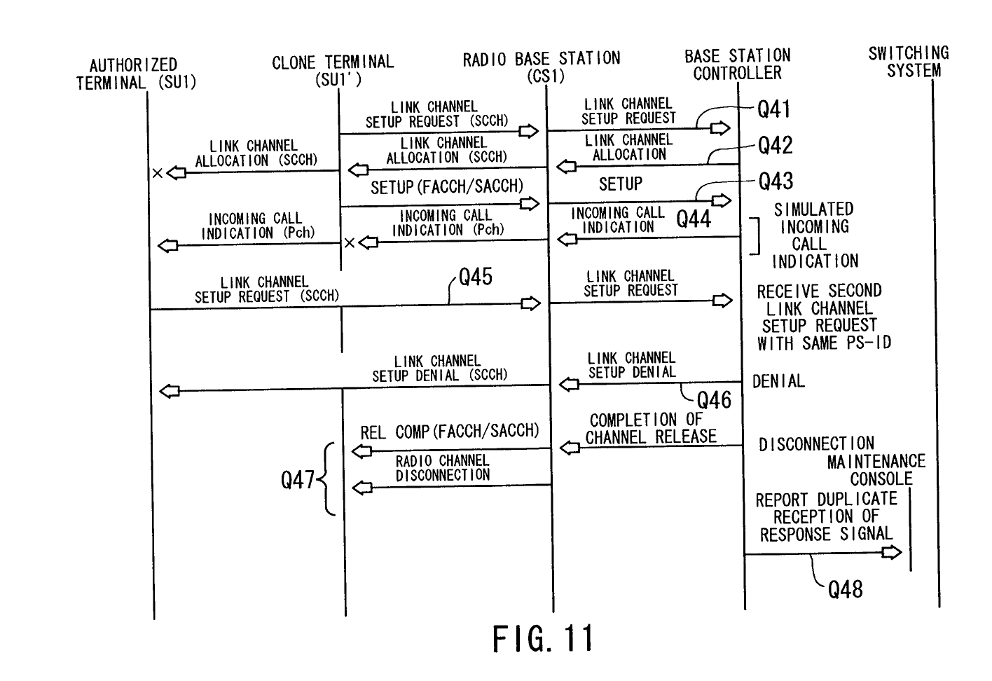

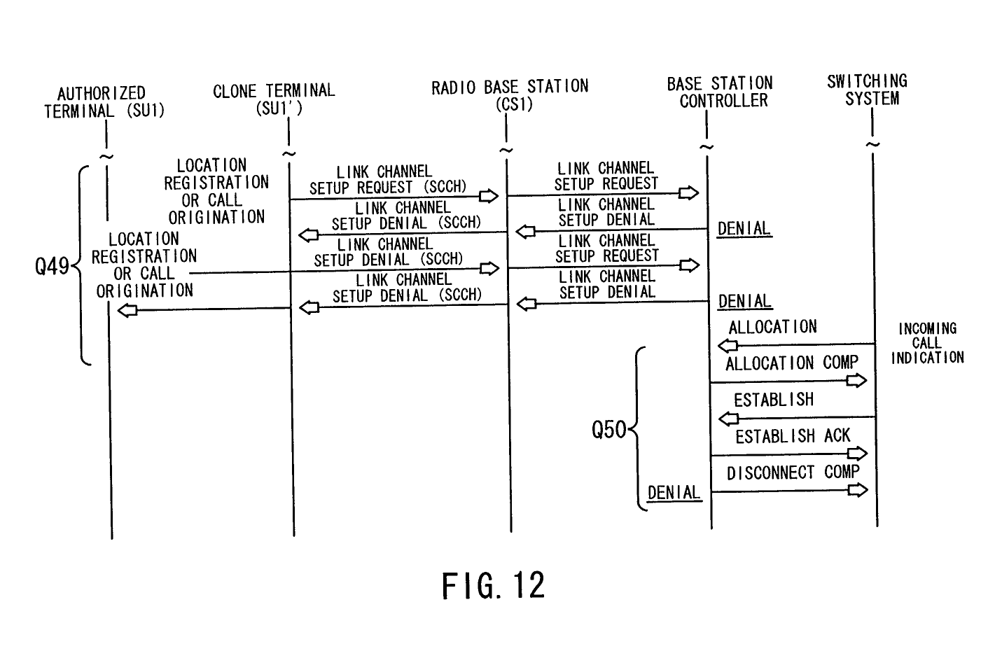

FIGS. 11 and 12 are the first and second halves of a sequence diagram which shows how the authorized terminal (SU1) 11 and the clone terminal (SU1′) 23 process an outgoing call. The following will describe the sequence of FIGS. 11 and 12, referring to the step numbers Q41 to Q50 as required.

To originate a call, the clone terminal (SU1′) 23 first transmits a link channel setup request signal having its own PS-ID, which is, however, equal to the authorized terminal (SU1) 1's PS-ID. This request signal reaches the base station controller 18 via the radio base station (CS1) 15 (Step Q41). In response to this, the call connection processor 39 in the base station controller 18 sends a link channel allocation signal to the clone terminal (SU1′) 23, without knowing it is a clone (Step Q42). Subsequently, the clone terminal (SU1′) 23 begins a call origination process by interacting with the base station controller 18 (Step Q43).

This call origination process triggers the transmission of a simulated incoming call indication signal having the clone terminal (SU1′) 23's PS-ID. Via the radio base station (CS1) 15, this indication signal is delivered from the call connection processor 39 to the simultaneous paging area (Z1) 21, where the clone terminal (SU1′) 23 and the authorized terminal (SU1) 11 are located (Step Q44). At the same time, the call connection processor 39 activates the T1 timer. The clone terminal (SU1′) 23, which has an established link channel, cannot receive the simulated incoming call indication signal, because this signal is sent over the paging channel (Pch).

In response to the simulated incoming call indication signal, the authorized terminal (SU1) 11 solely sends a link channel setup request signal with its own PS-ID back to the call connection processor 39 (Step Q45). Because it knows that the incoming call indication was just “simulated,” the call connection processor 39 responds to the link channel setup request signal by transmitting a link channel setup denial signal to the authorized terminal (SU1) 11 (Step Q46).

As a result of steps Q41 and Q45, the call connection processor 39 has received two link channel setup request signals in total. If the second signal reception was completed before the T1 timer expires, the call connection processor 39 detects the presence of a clone terminal having the same PS-ID as the authorized terminal (SU1) 11's PS-ID in the simultaneous paging area 21, and accordingly, it disconnects the existing link channel allocated to the clone terminal (SU1′) 23 (Step Q47). Further, the call connection processor 39 informs the maintenance console 20 that a clone terminal having the same PS-ID as that of the authorized terminal (SU1) 11 exists in the simultaneous paging area 21. (Step Q48). Moreover, the call connection processor 39 updates the subscriber management table 36 by entering an appropriate value to the “Presence of Clone” field relevant to authorized terminal (SU1) 11 to indicate the existence of a clone terminal, and terminates the sequence of the simulated incoming call indication.

As long as the record in the subscriber management table 36 shows the presence of a clone terminal, the base station controller 18 continues to reject any further link channel setup request signals from the concerned party. That is, even if the authorized terminal (SU1) 11 or clone terminal (SU1′) 23 desires to make a location registration or call origination, their request for link channel allocation will be denied by the call connection processor 39 (Step Q49). This access denial is also applied to incoming calls signaled from the switching system on the network 19 (Step Q50).

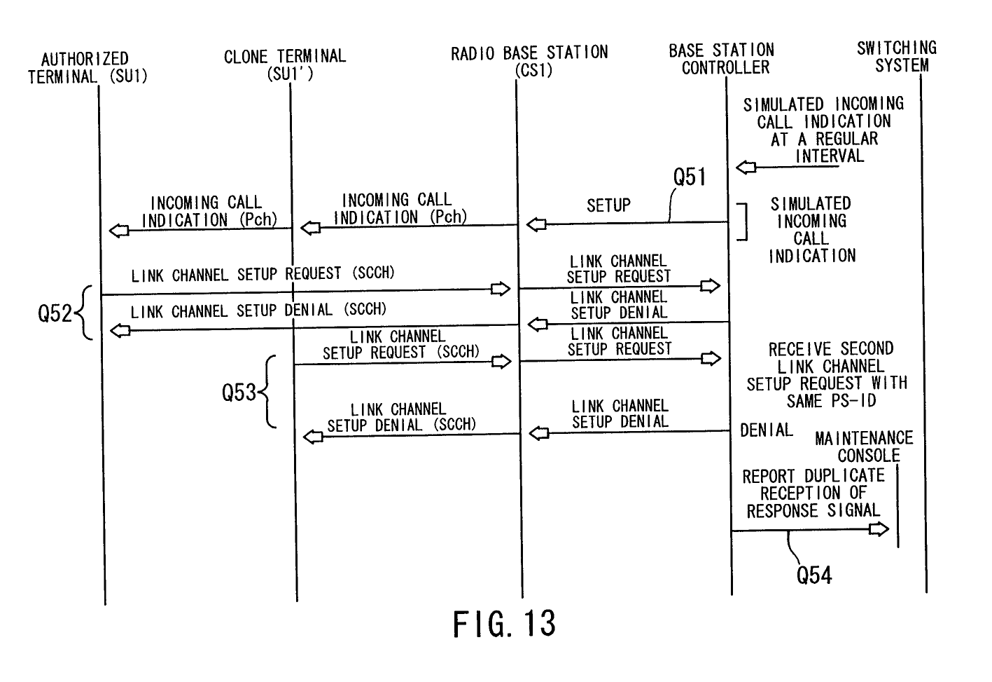

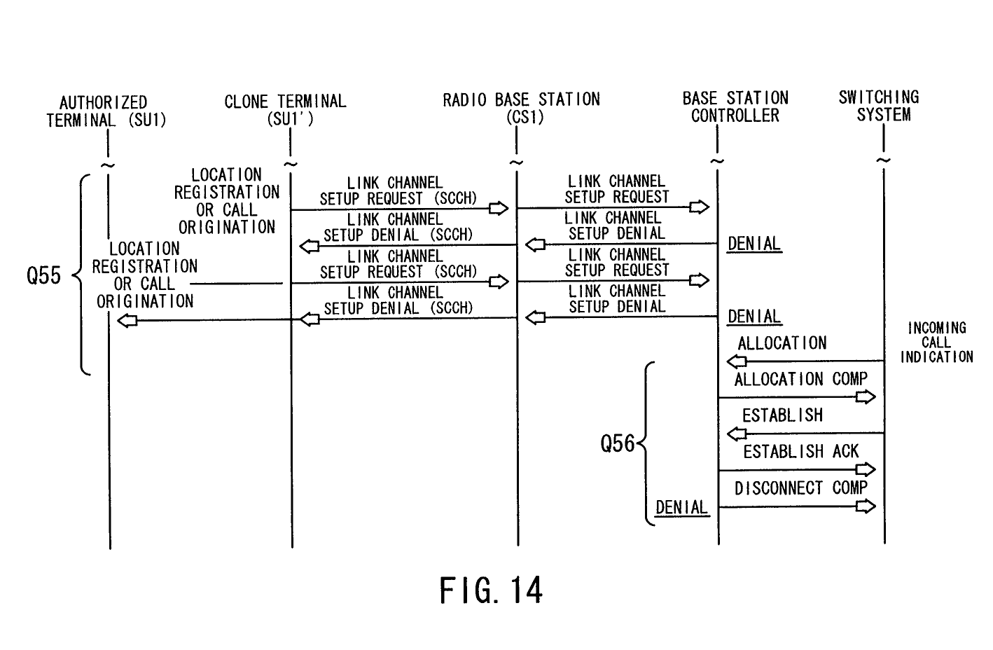

FIGS. 13 and 14 are the first and second halves of a sequence diagram which shows a process executed each time a simulated incoming call indication is cyclically invoked. Recall that this process occurs on a regular basis, at predetermined intervals, while scanning all subscriber terminals registered within a simultaneous paging area. FIGS. 13 and 14 illustrate a specific cycle where the simulated incoming call indication signal is addressed to the authorized terminal (SU1) 11. The following will describe the sequence of FIGS. 13 and 14, referring to the step numbers Q51 to Q56 as required.

When the predetermined time has expired and the authorized terminal (SU1) 11 is selected as the next target of challenge, the call connection processor 39 transmits a simulated incoming call indication signal having the authorized terminal (SU1) 11's PS-ID to the simultaneous paging area 21 (Step Q51). Recognizing that the received incoming call indication signal is addressed to itself, the authorized terminal (SU1) 11 sends a link channel setup request signal containing its own PS-ID back to the base station controller 18. The call connection processor 39 in the base station controller 18 receives the link channel setup request signal. Because it knows that the received request originated from a simulated incoming call indication signal, the call connection processor 39 sends a link channel setup denial signal to the authorized terminal (SU1) 11 (Step Q52).

The clone terminal (SU1′) 23 has also received the same incoming call indication signal as a message addressed to itself, and thus it returns a link channel setup request signal with its PS-ID to the base station controller 18. The call connection processor 39 in the base station controller 18 receives this second link channel setup request signal before the T1 timer expires. Because of the duplicate reception, it returns a link channel setup denial signal to the clone terminal (SU1′) 23 (Step Q53).

As a result of steps Q52 and Q53, the call connection processor 39 has received two link channel setup request signals in total, thus recognizing the existence of a clone terminal having the same PS-ID as that of the authorized terminal (SU1) 11 in the simultaneous paging area 21. Accordingly, the call connection processor 39 reports the problem to the maintenance console 20 (Step Q54). Further, the call connection processor 39 updates the subscriber management table 36 by entering an appropriate value to the “Presence of Clone” field relevant to authorized terminal (SU1) 11 to indicate the existence of a clone terminal, and terminates the sequence of the simulated incoming call indication.

As long as the record in the subscriber management table 36 shows the presence of a clone terminal, the base station controller 18 continues to reject further link channel setup request signals from the concerned party. That is, even if the authorized terminal (SU1) 11 or clone terminal (SU1′) 23 desires to make a location registration or call origination, their request for link channel allocation will be denied by the call connection processor 39 (Step Q55). The same access denial is applied to any incoming calls to the authorized terminal (SU1) 11 signaled from the switching system on the network 19 (Step Q56).

As described above, the present invention is based on the premise that subscriber terminals are not mobile stations, but fixed terminals. Taking advantage of this nature of the system, and also utilizing the subscribers' personal identifiers (PS-IDs), the base station controller sends a simulated incoming call indication signal to a subscriber terminal in some predetermined conditions including (a) upon location registration, (b) upon origination of an outgoing call, (c) upon reception of an incoming call, and (d) at a regular interval. (To be exact, it sends a true incoming call indication signal in the case (c).) The base station controller detects the presence of a clone terminal from the reception of a plurality of response signals. When a clone terminal is found, the base station controller interrupts the connection of the subscriber terminal and/or the clone terminal sharing the same PS-ID, thereby prohibiting their location registration and further call attempts.

Once the presence of a clone terminal is identified, the subscriber terminals concerned are unable to make access to other subscriber terminals. In order to regain access, the subscriber terminal should be reconfigured to have a new PS-ID assignment by rewriting the ROM and updating the subscriber management table under the control of the base station controller. The relevant “Presence of Clone” field in the table should also be reset to a “No Clones” state.

Now, the following section will describe the second embodiment of the present invention. Since the second embodiment has basically the same structure as that of the first embodiment, the following section will assume the same system configuration as in the first embodiment.

The second embodiment, however, differs from the first embodiment in the process executed by the base station controller 18 after the detection of a clone terminal. More specifically, the base station controller 18 in the second embodiment will skip step S7 in the flowchart of FIG. 5, while it generally follows the process flow depicted in FIG. 5.

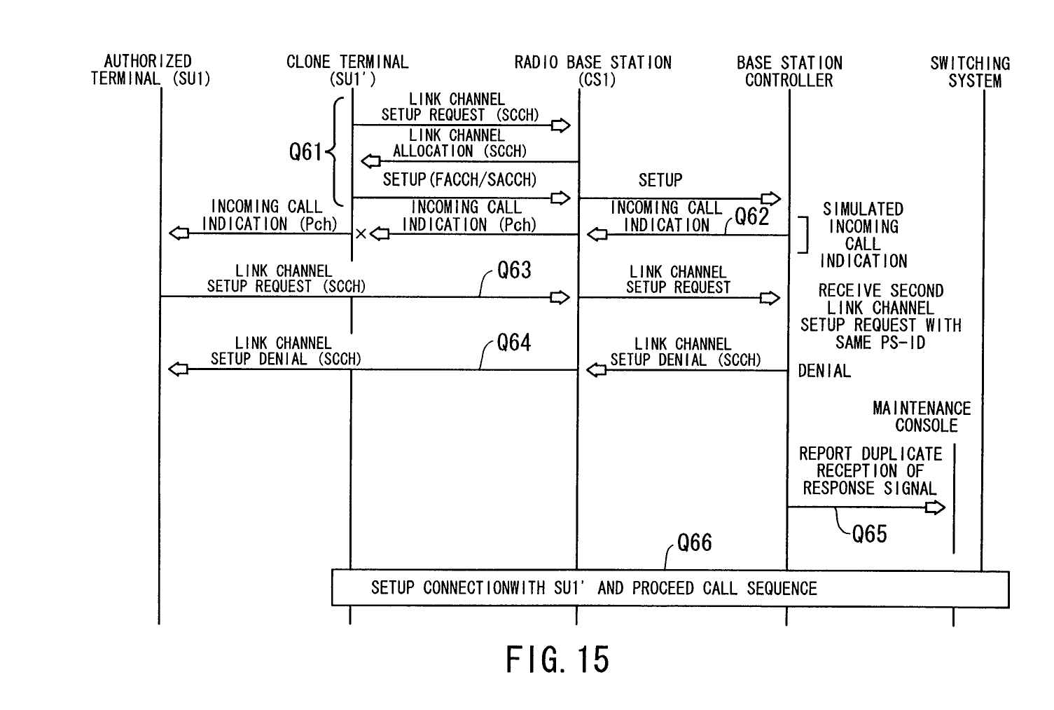

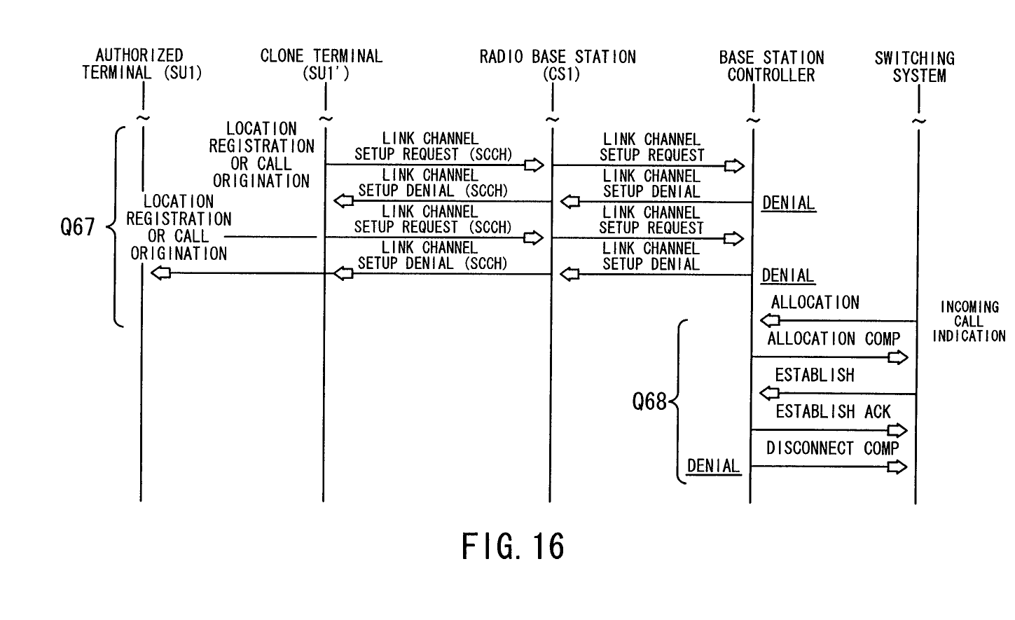

FIGS. 15 and 16 are the first and second halves of a sequence diagram which shows how the base station controller 18 works in the second embodiment, particularly in the case that the authorized terminal (SU1) and the clone terminal (SU1′) attempt to originate an outgoing call.

Unlike the first embodiment, the detection of a clone terminal does not interrupt the ongoing communication session and/or call connection process, but allows them to continue for the time being and inhibits the next call attempt and location registration. The following will describe the sequence of FIGS. 15 and 16, referring to the step numbers Q61 to Q68 as required.

In an attempt to originate a call, the clone terminal (SU1′) 23 first transmits a link channel setup request signal having its own PS-ID, which is, however, equal to the authorized terminal (SU1) 11's PS-ID. This request signal reaches the radio base station (CS1) 15, and in response to this, the radio base station (CS1) 15 sends a link channel allocation signal back to the clone terminal (SU1′) 23. Subsequently, the clone terminal (SU1′) 23 begins a call origination process by interacting with the base station controller 18 (Step Q61).

This call origination process triggers the transmission of a simulated incoming call indication signal having the clone terminal (SU1′) 23's PS-ID. Via the radio base station (CS1) 15, this indication signal is delivered from the call connection processor 39 to the simultaneous paging area (Z1) 21, where the clone terminal (SU1′) 23 and the authorized terminal (SU1) 11 are located (Step Q62). At the same time, the call connection processor 39 activates the T1 timer. The clone terminal (SU1′) 23, to which a link channel has been allocated, cannot receive the simulated incoming call indication signal, because it is transmitted over the paging channel (Pch).

Upon receipt of the simulated incoming call indication signal, the authorized terminal (SU1) 11 sends a link channel setup request signal with its own PS-ID back to the call connection processor 39 (Step Q63). Because it knows that the transmitted indication signal was only a “simulated” version, the call connection processor 39 responds to the link channel setup request signal by giving a link channel setup denial signal to the authorized terminal (SU1) 11 (Step Q64).

As a result of steps Q61 and Q63, the call connection processor 39 has received two link channel setup request signals in total. If the second reception was made before the Ti timer expires, the call connection processor 39 recognizes that a clone terminal having the same PS-ID as the authorized terminal (SU1) 11's PS-ID exists in the simultaneous paging area 21. Accordingly, it informs the maintenance console 20 of the duplicate reception (Step Q65). Further, the call connection processor 39 updates the “Presence of Clone” field relevant to authorized terminal (SU1) 11 to indicate the existence of a clone terminal.

In the second embodiment, the base station controller 18 does not immediately responds to the detection of a clone terminal. Instead, it continues the ongoing call origination process, thus allowing the clone terminal (SU1′) 23 to use the services (Step Q66).

After the present session is terminated, the base station controller 18 rejects further link channel setup request signals from the party concerned, as long as the record in the subscriber management table 36 shows the presence of a clone terminal. That is, even if the authorized terminal (SU1) 11 or clone terminal (SU1′) 23 desires to make a location registration or call origination, their request for link channel allocation will be denied by the call connection processor 39 (Step Q67). The same access denial is applied to any incoming calls to the authorized terminal (SU1) 11 signaled from the switching system on the network 19 (Step Q68).

According to the above sequence, the base station controller 18 continues the ongoing call origination process for the clone terminal (SU1′) 23, although it knows that the calling terminal is a clone. Thus the communication link becomes available to the clone terminal 23. Such a sequence is applied not only to the call origination, but also to other events, which include location registration, reception of incoming calls, and regular intervals. Despite the presence of a clone terminal, the base station controller 18 proceeds the session with the clone terminal (SU1′) 23, thus allowing it to use the communication channel for the time being.

Now, the following paragraphs will describe a third embodiment of the present invention. Since the third embodiment has basically the same structure as that of the first embodiment, the following section will assume the same system configuration as in the first embodiment. The third embodiment, however, is distinguishable from the first embodiment in that the base station controller 18 operates differently after a clone terminal is detected.

When an unauthorized subscriber terminal (i.e., clone terminal) is found, the base station controller in the third embodiment rejects the call connection requested by this unauthorized subscriber terminal and a regular subscriber terminal that shares the same PS-ID, as in the first embodiment. The third embodiment, however, is different from the first embodiment in that the base station controller accepts their requests for call origination, call reception, and location registration from the next time. In other words, the third embodiment generally follows the sequence diagrams of FIGS. 8 to 14, but modifies the following steps described in the earlier sections: Q11 and Q12 in FIG. 8; Q30 and Q31 in FIG. 10; Q49 and Q50 in FIG. 12; Q55 and Q56 in FIG. 14.

It is noted that, in reality, the regular subscriber terminals may retransmit another response signal (i.e., a link channel setup request signal) in reply to a simulated incoming call indication signal. Since the foregoing three embodiments do not take such a situation into consideration, the base station controller will mistake the retransmission of the same response signal for the sign of a clone terminal. To avoid this mistake, the base station controller can be configured to simulate the incoming call indication signal once again when it suspects that a clone terminal is present. If the base station controller receives again a plurality of response signals with the same PS-ID, it will say with certainty that a clone terminal is there.

Although the foregoing three embodiments uses a simulated incoming call indication signal to detect clone terminals, the present invention is not restricted to this particular type of message. It is also possible to use other signals if they satisfy the following requirements:

(a) the signal can convey the identification code of a specific subscriber terminal selected as a target of challenge,

(b) the signal can be delivered to all subscriber terminals in a simultaneous paging area, and

(c) the signal can request the subscriber terminals (including clones) sharing the same identification code to send back a response signal.

The above discussion is summarized as follows. The present invention provides a way to detect an unauthorized subscriber terminal being used in a telecommunications system employing a wireless access method, such as the WLL, to interact with fixed terminals. Being triggered by some predetermined events, the base station controller transmits a response request signal to each registered subscriber terminal, and upon receipt of a plurality of response signals, it detects the presence of an unauthorized subscriber terminal (or clone terminal). The base station controller then takes appropriate countermeasures to the fake-terminal attack. In this way, the present invention makes it possible to detect clone terminals and take measures to remove them from the network.

Accordingly, the authorized subscribers will be protected from unexpected call charges due to the illegal use of communication services by clone terminals. Note that the attack from clone terminals would cause various losses and damages in telecommunications systems. For example, the increased communication traffic leads to a reduction in the availability of network and user resources; the common carriers are unable to charge for the calls that unauthorized users have made; the service providers would lose their good reputation that have been earned from their clients. The present invention eliminates all those risks associated with the clone subscribers.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A communication control apparatus, disposed in a radio communications system where a plurality of subscriber terminals communicate with each via radio base stations, for managing locations of the subscriber terminals and controlling incoming and outgoing calls to/from the subscriber terminals, comprising:
response request signal transmission means for transmitting, upon predetermined conditions, a response request signal containing an identification code of a specific subscriber terminal by using a radio link via the base stations which cover an area where the specific subscriber terminal is located; and
judgement means for recognizing the presence of an unauthorized subscriber terminal having the same identification code as the specific subscriber terminal's identification code, if a plurality of response signals have been received in reply to the response request signal intended for the specific subscriber terminal.

2. The communication control apparatus according to claim 1, wherein the predetermined conditions include location registration requested by each subscriber terminal.

3. The communication control apparatus according to claim 1, wherein the predetermined conditions include reception of an incoming call.

4. The communication control apparatus according to claim 1, wherein the predetermined conditions include origination of an outgoing call.

5. The communication control apparatus according to claim 1, wherein the predetermined conditions include expiration of a predetermined time interval.

6. The communication control apparatus according to claim 1, further comprising:
disconnection means, activated when said judgement means has recognized the presence of the unauthorized subscriber terminal, for disconnecting call connections concerning all subscriber terminals sharing the same identification code that the unauthorized subscriber terminal uses; and
call denial means for denying at least origination of outgoing calls and reception of incoming calls concerning all subscriber terminals sharing the same identification code that the unauthorized subscriber terminal uses, after said judgement means has recognized the presence of the unauthorized subscriber terminal.

7. The communication control apparatus according to claim 1, further comprising:
link channel setup denial means, activated when said judgement means has recognized the presence of the unauthorized subscriber terminal, for denying allocation of a link channel to the specific subscriber terminal; and
call denial means for denying at least origination of outgoing calls and reception of incoming calls concerning all subscriber terminals sharing the same identification code that the unauthorized subscriber terminal uses, after said judgement means has recognized the presence of the unauthorized subscriber terminal.

8. The communication control apparatus according to claim 1, further comprising disconnection means, activated when said judgement means has recognized the presence of the unauthorized subscriber terminal, for interrupting call connections concerning all subscriber terminals sharing the same identification code that the unauthorized subscriber terminal uses.

9. A radio communications system which allows a plurality of subscriber terminals to communicate with each other via radio base stations by employing a communication controller coupled to the radio base stations for managing locations of the subscriber terminals and controlling incoming and outgoing calls to/from the subscriber terminals, the radio communications system comprising:
means activated upon predetermined conditions for transmitting a response request signal from the communication controller to a specific subscriber terminal by using a radio link via one of the radio base stations which covers an area where the specific subscriber terminal is located, said response request signal containing an identification code of the specific subscriber terminal;
means for transmitting a response signal, in reply to the response request signal, from the subscriber terminal having the same identification code as that contained in the response request signal to the communication controller via the one of the radio base stations; and
means for recognizing the presence of an unauthorized subscriber terminal having the same identification code as the specific subscriber terminal's identification code, if a plurality of response signals have been returned in reply to the response request signal intended for the specific subscriber terminal.
